(19) United States
(12) Patent Application Publication
(10) Pub. No.: US 2007/0031075 A1
(43) Pub. Date: Feb. 8, 2007

(54) Thrust roller bearing and torque converter

(76) Inventors: Kazuyuki Yamamoto, Hamamatsu-shi (JP); Kousuke Obayashi, Fukuroi-shi (JP)

Correspondence Address: CLARK & BRODY, 1090 VERMONT AVENUE, NW, SUITE 250, WASHINGTON, DC, 20005, US

(21) Appl. No.: 11/498,882

(22) Filed: Aug. 4, 2006

(30) Foreign Application Priority Data
Aug. 8, 2005 (JP) JP2005-229702

(51) Int. Cl. F16C 17/04

(52) U.S. Cl. 384/420

(57) ABSTRACT

A thrust roller bearing comprises an inner ring and an outer ring as orbit rings, a plurality of rollers arranged between the inner ring and the outer ring, and a retainer having pockets for housing the plurality of rollers. The retainer is formed by attaching two annular members and caulking an inner edge of one annular member and an outer edge of the other annular member. The outer ring comprises a retainer separation preventing click that engages with the retainer, in its outer edge.

### BACKGROUND OF THE INVENTION

1. Field of the Invention

The present invention relates to a thrust roller bearing and more particularly, to a thrust roller bearing used at a position in which an eccentric rotation is generated, such as a transmission and a torque converter of a car.

2. Description of the Background Art

Conventionally, as a bearing used at a transmission or a torque converter of a car, a thrust roller bearing 1 shown in FIGS. 6A and 6B is used. The thrust roller bearing 1 comprises an inner ring 2, an outer ring 3, a plurality of rollers 4 arranged between the inner ring 2 and the outer ring 3, and a retainer 5 having pockets for housing the plurality of rollers 4.

The retainer 5 comprises a first flat part 5a positioned at an annular outer edge on one side of a thickness direction, a second flat part 5b positioned at the center of the pocket on the other side of the thickness direction, and an inclined part provided between the first and second flat parts 5a and 5b. An end face of the pocket in a diameter direction is arranged at the first flat part 5a.

Since the eccentric rotation is generated at the transmission or the torque converter of the car, the rollers 4 of the thrust roller bearing 1 is caused to slide. In addition, as lubricating oil used in the transmission or the torque converter, lubricating oil having low viscosity is used in view of fuel saving, so that when the roller 4 is caused to slide, an oil film could be cut between the roller 4, and the inner ring 2 and the outer ring 3, which causes the retainer 5 to be damaged, worn due to a lubrication defect, peeled from a surface and the like.

Thus, a thrust roller bearing used under an eccentric rotation is disclosed in Japanese Unexamined Patent Publication No. 2003-83339. According to this document, a gap 6 between an outer ring 3 and a retainer 5 (referred to as the “bearing inner gap” hereinafter) is provided so that the thrust roller bearing can be used under the eccentric rotation.

Furthermore, according to the thrust roller bearing disclosed in the document, when the bearing inner gap 6 is largely set, since the retainer 5 could escape from the outer ring 3, a retainer separation preventing click 3a that engages with a first flat part 5a of the retainer 5 is provided at the outer edge of the outer ring 3 to prevent the retainer 5 from falling off.

Furthermore, Japanese Unexamined Patent Publication No. 2003-97562 discloses a thrust roller bearing in which two rollers are housed in each pocket of a retainer, or a thrust roller bearing comprising a roller whose rotation face is crowned. Thus, when an effective length of the roller is reduced, the roller can be prevented from sliding.

In a case where the above described thrust roller bearing 1 is used in an eccentric circumstance such as the transmission or the torque converter, when an eccentric amount of a supporting member exceeds the bearing inner gap 6, the retainer 5 comes into contact with the outer edge of the outer ring 2 during rotation of the bearing. Since the retainer 5 is low in rigidity as compared with the outer ring 2, the retainer 5 could be worn or damaged due to the contact with the outer ring 2.

### SUMMARY OF THE INVENTION

It is an object of the present invention to provide a thrust roller bearing comprising a retainer that is improved in rigidity at an edge that comes into contact with an outer ring and in abrasion resistance.

A thrust roller bearing according to the present invention comprises a plurality of rollers, a retainer having pockets for housing the plurality of rollers, and an orbit ring having a retainer separation preventing click for restraining the retainer by engaging with the retainer. A thickness of an edge of the retainer is larger than a board thickness of the retainer.

According to the above retainer, since the edge of the retainer that comes into contact with the outer ring is rigid, even when it is used under an eccentric rotation, the retainer can be prevented from being worn in an early stage or damaged. As a result, the thrust roller bearing is superior in durability.

Preferably, the retainer has a constitution in which two annular members are attached and outer edges and inner edges of them are connected. Since the above retainer comprises the two annular members, the retainer can be rigid as a whole.

Further preferably, a thickness of each of the outer edge and inner edge of the retainer is more than three times as large as a board thickness of the annular member. Since the thickness of each of the outer edge and the inner edge is more than three times as large as the board thickness of the annular member, the part of the retainer that comes into contact with the outer ring can be sufficiently rigid. As a result, the thrust roller bearing is superior in durability.

Preferably, a thickness of a roller retainer of the retainer is larger than that of an inner periphery and an outer periphery of the retainer positioned inner and outer sides of the roller retainer. Thus, when the thickness of the roller retainer on each of the inner side and the outer side of the roller retainer is small, lubricating oil can easily flow in and out, so that an amount of the lubricating oil that passes through the bearing per unit time can be increased.

Preferably, the rollers are arranged in double rows in a diameter direction of the bearing. According to the above constitution, since a roller length is short, the roller is prevented from sliding. As a result, the thrust roller bearing can be used in a circumstance in which an eccentric rotation is generated such as a transmission or a torque converter.

A torque converter according to the present invention comprises an impeller connected to an input shaft, a turbine connected to an output shaft, a stator arranged between the impeller and the turbine, and a thrust roller bearing that supports the impeller and the stator, and the stator and the turbine rotatably. The thrust roller bearing comprises a plurality of rollers, a retainer having pockets for housing the plurality rollers, and an orbit ring having a retainer separation preventing click for restraining the retainer by engaging with the retainer, in which a thickness of an edge of the retainer is larger than a board thickness of the retainer.

Since the above thrust roller bearing can be used under the eccentric rotation, and the edge of the retainer that comes into contact with the outer ring is high in rigidity, the torque converter is superior in durability.

According to the present invention, by increasing the thickness of the edge of the retainer that comes into contact with the outer ring, the thrust roller bearing is superior in durability.

### BRIEF DESCRIPTION OF THE DRAWINGS

FIG. 1A is a plan view showing a thrust roller bearing according to one embodiment of the present invention;

FIG. 1B is a side sectional view showing the thrust roller bearing according to one embodiment of the present invention;

FIG. 2 is a partially enlarged view showing the thrust roller bearing shown in FIG. 1;

FIG. 3A is a plan view showing a thrust roller bearing according to another embodiment of the present invention;

FIG. 3B is a side sectional view showing the thrust roller bearing according to another embodiment of the present invention;

FIG. 4A is a view showing an end face of a roller used in the thrust roller bearing according to one embodiment of the present invention;

FIG. 4B is a view showing an end face of a roller used in the thrust roller bearing according to another embodiment of the present invention;

FIG. 5 is a view showing a torque converter according to one embodiment of the present invention;

FIG. 6A is a plan view showing a conventional thrust roller bearing; and

FIG. 6B is a side sectional view showing the conventional thrust roller bearing.

### DESCRIPTION OF THE PREFERRED EMBODIMENTS

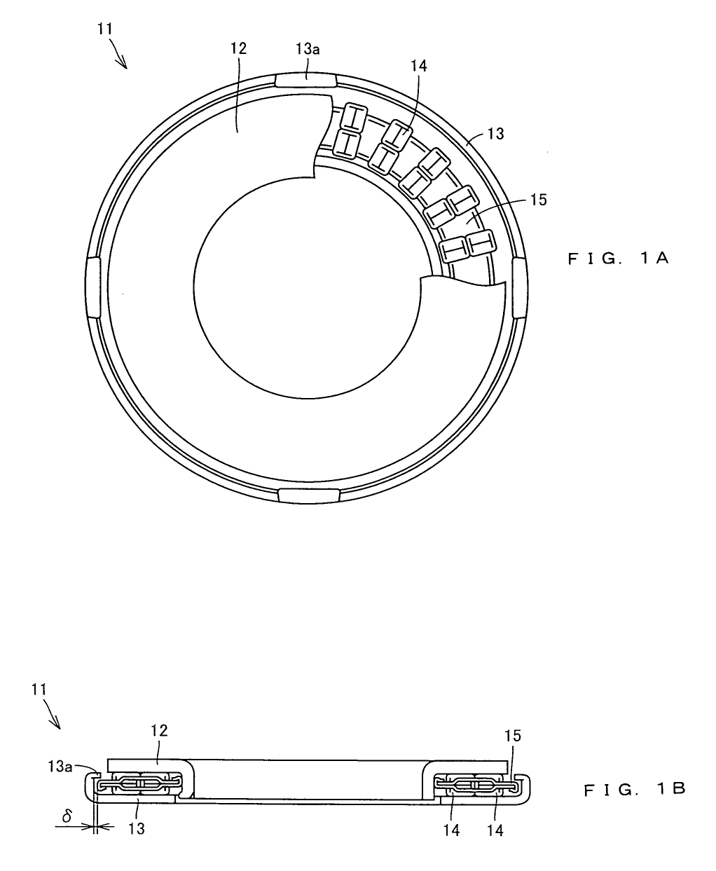

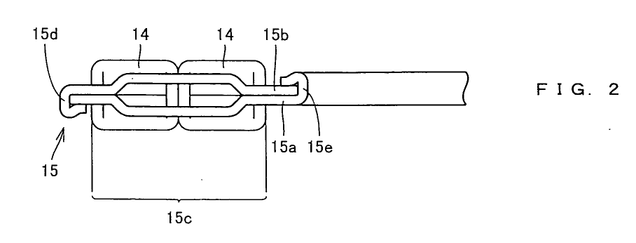

A thrust roller bearing according to one embodiment of the present invention will be described with reference to FIGS. 1A, 1B, 2A and 2B hereinafter.

A thrust roller bearing 11 shown in FIGS. 1A and 1B comprises an inner ring 12 and an outer ring 13 serving as orbit rings, a plurality of rollers 14 arranged between the inner ring 12 and the outer ring 13, and a retainer 15 having pockets 15c for housing the plurality of rollers 14. The retainer 15 is elastically deformed and set in the outer ring 13 and then the rollers 14 and the inner ring 12 are incorporated, whereby the thrust roller bearing 11 is completed.

Since the above thrust roller bearing 11 is used in a circumstance where an eccentric rotation is generated such as a transmission or a torque converter of a car, a bearing inner gap 6 between the outer ring 13 and the retainer 15 is set more than twice as large as an eccentric amount of a supporting member. In addition, in order to prevent the retainer 15 from escaping from the outer ring 13 when the bearing inner gap 6 is set large, a retainer separation preventing click 13a for restraining the retainer 15 by engaging with the retainer 15 is provided at an outer edge of the outer ring 13.

The retainer separation preventing click 13a is formed through a bending process. For example, when the retainer separation preventing click 13a is formed by staking, since it is difficult to enlarge a projection amount, it cannot be used in the bearing that supports the transmission or the torque converter and the like having a large eccentric amount. Furthermore, since the retainer separation preventing click 13a formed by staking is highly rigid, it is difficult to incorporate the retainer 15.

Thus, by using the bending process, the retainer separation preventing click 13a having a required projection amount can be easily provided. In addition, when a board thickness is reduced by a fluting process prior to manufacturing the retainer separation preventing click 13a, the bending process can be easily performed at the fluting-processed part as a start point. According to the above constitution, the thrust roller bearing can be used under an eccentric rotation and prevent the retainer 15 from escaping.

As shown in FIG. 2, the retainer 15 comprises two annular members 15a and 15b attached to each other and bonded such that an end of one annular member is caulked or bent toward the other annular member. According to the above embodiment, an inner edge of the annular member 15a and an outer edge of the annular member 15b are caulked.

Since the above retainer 15 comprises the two annular members, it is highly rigid. Furthermore, when a thickness of each of caulked parts 15d and 15e provided at the inner edge and the outer edge of the retainer 15 is set so as to be more than three times as large as a thickness of each of the annular members 15a and 15b, the caulked parts 15d and 15e can be further highly rigid. As a result, even when the thrust roller bearing 11 is used under the eccentric rotation, the retainer 15 is prevented from being worn in an early stage or being damaged.

A space between the two annular members 15a and 15b is enlarged in the region of the pocket 15c for housing the roller 14 to form a roller retainer to prevent the roller 14 from falling off in an axial direction. In addition, a thickness of the roller retainer is set larger than that of an inner peripheral part and an outer peripheral part of the retainer positioned inner and outer sides of the roller retainer. Thus, when the thickness on the inner and outer sides of the roller retainer is small, lubricating oil can easily flow in and out, so that an amount of the lubricating oil passing through the bearing per unit time can be increased.

Meanwhile, the roller 14 slides due to a difference in circumferential velocity on both ends of the roller 14. Thus, the thrust roller bearing 11 has double rows for housing two rollers 14 in each pocket. Thus, when the rollers 14 are arranged in a diameter direction of the bearing in double rows, an effective length of the roller 14 is reduced, so that the sliding of the roller 14 due to the eccentric rotation can be prevented.

The thrust roller bearing 11 having the above constitution can be used under the eccentric rotation and effectively prevent the retainer 15 from being escaped. Furthermore, since the inner and outer edges of the retainer 15 are rigid, the thrust roller bearing 11 is superior in durability.

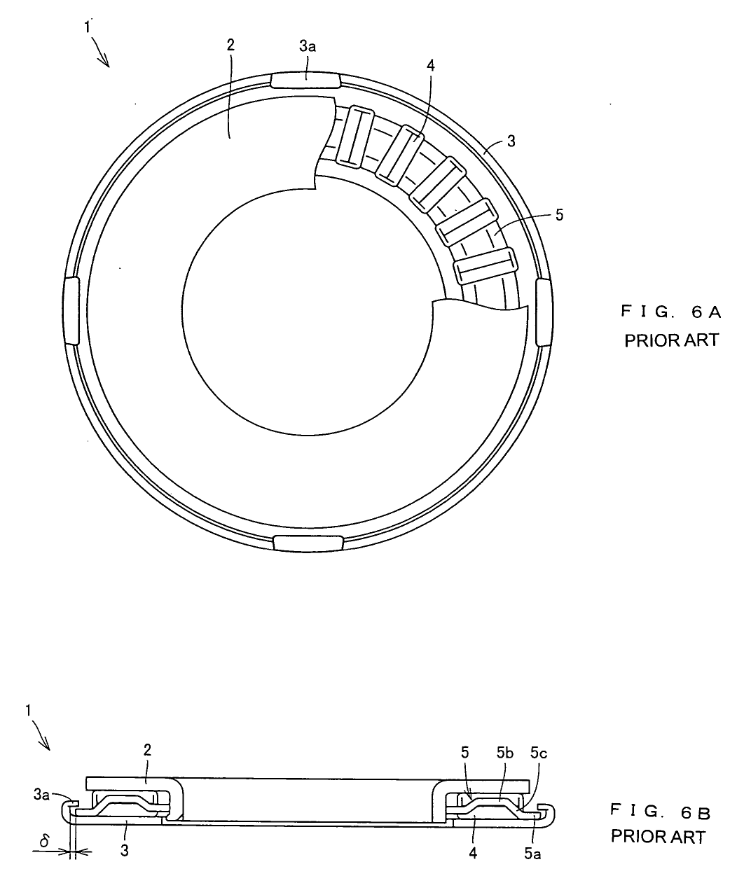

Although the retainer 15 comprising the two attached annular members 15a and 15b is illustrated in the above embodiment, the present invention is not limited to this type. For example, by increasing a thickness of an edge of the retainer consisting of one annular member as shown in FIGS. 6A and 6B, the effect of the present invention can be provided.

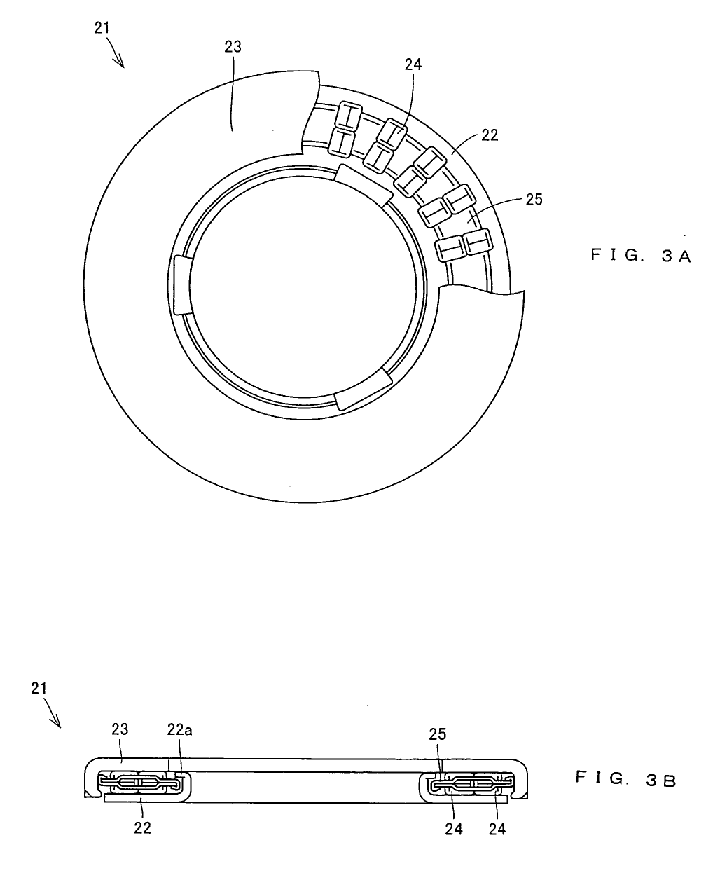

Although the example in which the retainer separation preventing click 13a is provided at a part of the outer edge of the outer ring 13 is illustrated in the above embodiment, a retainer separation preventing click may be provided over an entire periphery of the outer edge. In addition, as shown in FIGS. 3A and 3B, a retainer separation preventing click 22a may be provided in an inner edge of an inner ring. 22. In this case, a constitution other than that is the same as that of the thrust roller bearing 11 shown in FIGS. 1A and 1B.

Furthermore, although the double-row thrust roller bearing 11 in which two rollers are provided in one pocket is illustrated in the above embodiment, the present invention is not limited to this and it may be applied to a single-row retainer or a thrust roller bearing comprising a retainer having a plurality of pockets in a diameter direction.

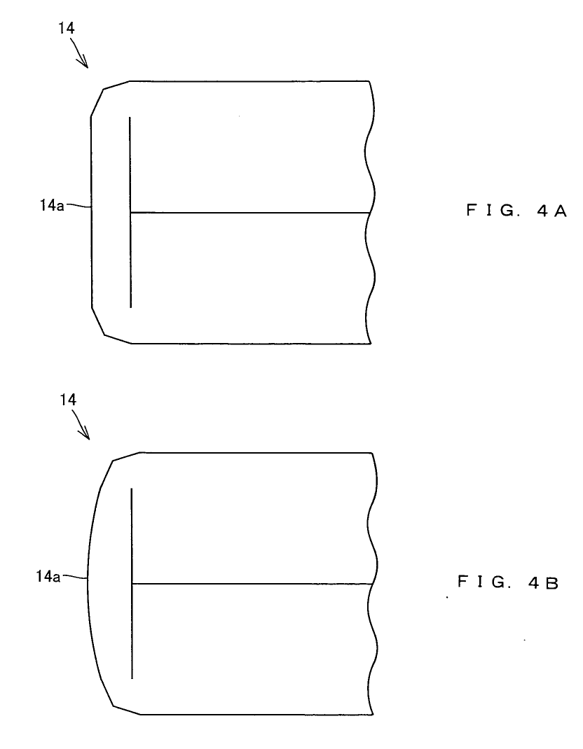

In addition, although the example in which the roller 14 having a flat “F” end face 14a having end face precision of 30 μm or less is illustrated in FIG. 4A, the present invention is not limited to this and a roller 14 having a round “A” end face 14a as shown in FIG. 4B may be arranged at a part of a thrust roller bearing or an entire part thereof. Furthermore, an entire rolling face or both ends of the roller 14 may be crowned.

In addition, the “F” end face and the “A” end face designate configurations of codes “A” and “F” defined in JIS B1506 (Japanese Industrial Standards).

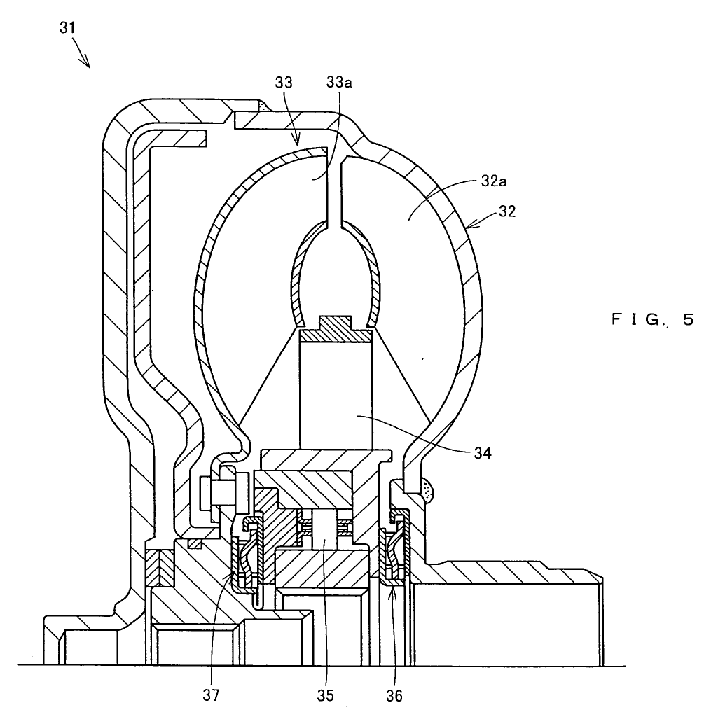

Next, a torque converter 31 according to one embodiment of the present invention will be described with reference to FIG. 5.

The torque converter 31 comprises an impeller 32 connected to an input shaft that transmits a rotation of an engine, a turbine 33 connected to an output shaft that transmits the rotation of the engine to a transmission through the torque converter 31, and a stator 34 provided in a stator shaft (not shown) between the impeller 32 and the turbine 33 through a unidirectional clutch 35, and encloses viscous fluid. Thrust roller bearings 36 and 37 are provided between the impeller 32 and the stator 34, and the stator 34 and the turbine 33 so as to support both of them, respectively.

According to the torque converter 3 having the above constitution, an impeller blade 32a generates flow of the viscous fluid, and a turbine blade 33a receives inertia force of the flow and drives the output shaft. The stator 34 returns the viscous fluid from the turbine blade 33a to the impeller blade 32a to amplify torque.

Here, since a fluid pressure applied to the impeller blade 32a and the turbine blade 33a is not always uniform in a circumferential direction, the impeller 32 and the turbine 33 are likely to generate an eccentric rotation. Thus, when the thrust roller bearing according to one embodiment of the present invention as shown in FIGS. 1A and 1B or FIGS. 3A and 3B is used as the thrust roller bearings 36 and 37 that support the above components, the torque converter 31 is superior in durability.

Although the embodiments of the present invention have been described with reference to the drawings in the above, the present invention is not limited to the above-illustrated embodiments. Various kinds of modifications and variations may be added to the illustrated embodiments within the same or equal scope of the present invention.

The present invention can be advantageously used for the thrust roller bearing used under the eccentric rotation.

What is claimed is:

1. A thrust roller bearing comprising:
a plurality of rollers;
a retainer having pockets for housing said plurality of rollers; and
an orbit ring having a retainer separation preventing click for restraining said retainer by engaging with said retainer, wherein
a thickness of an edge of said retainer is larger than a board thickness of said retainer.

2. The thrust roller bearing according to claim 1, wherein said retainer has a constitution in which two annular members are attached and outer edges and inner edges of them are connected.

3. The thrust roller bearing according to claim 2, wherein a thickness of each of the outer edge and inner edge of the retainer is more than three times as large as a board thickness of said annular member.

4. The thrust roller bearing according to claim 1, wherein a thickness of a roller retainer of said retainer is larger than that of an inner periphery and an outer periphery of the retainer positioned inner and outer sides of the roller retainer.

5. The thrust roller bearing according to claim 1, wherein said rollers are arranged in double rows in a diameter direction of the bearing.

6. A torque converter comprising:
an impeller connected to an input shaft;
a turbine connected to an output shaft;
a stator arranged between said impeller and said turbine; and
a thrust roller bearing that supports said impeller and said stator, and said stator and said turbine rotatably, wherein
said thrust roller bearing comprises a plurality of rollers, a retainer having pockets for housing said plurality of rollers, and an orbit ring having a retainer separation preventing click for restraining said retainer by engaging with said retainer, in which a thickness of an edge of said retainer is larger than a board thickness of said retainer.
